(19) United States
(12) Patent Application Publication
(10) Pub. No.: US 2019/0118160 A1
(43) Pub. Date: Apr. 25, 2019

(54) POLLUTANT-REDUCING MINERAL POLYMERS

(71) Applicant: Alsitek Limited, Peterborough (GB)

(72) Inventors: Harun Ihsan, Peterborough (GB); Michael Reid, Peterborough (GB); Uzair Bapu, Peterborough (GB)

(21) Appl. No.: 15/576,638

(22) PCT Filed: May 23, 2016
(86) PCT No.: PCT/GB2016/051480

§ 371 Date: Nov. 22, 2017

(30) Foreign Application Priority Data
May 22, 2015 (GB) 1508865.1
Apr. 12, 2016 (GB) 1606295.2

(51) Int. Cl. B01J 20/16; B01D 53/04; B01J 20/34

(52) U.S. Cl. CPC B01J 20/16; B01D 53/04; B01J 20/3408; B01J 20/3475; B01J 20/3483; B01D 2253/11; B01D 2259/40083; B01D 2257/302; B01D 2257/404; B01D 2257/504; B01D 2257/708; B01D 2259/40088; B01D 2253/31

(57) ABSTRACT

A mineral polymer for reducing pollutants, in particular for gas absorbing, absorbing pollutant volatile organic compounds such as volatile organic hydrocarbons and/or capturing particulate pollutants. The mineral polymer may be a metakaolin-based mineral polymer with a porous or non-porous structure. The use of the mineral polymer for reducing pollutants includes for absorbing one or more pollutant gases, such as NOx (such as NO₂), SOx (such as SO₂) and/or CO₂, for absorbing pollutant volatile organic compounds such as volatile organic hydrocarbons and/or for capturing particulate pollutants, such as those produced by diesel engines. The pollutants are removed directly from the engine exhaust, from a ventilation system, or at the road side. A method for reducing pollutants comprises the steps: (i) providing the mineral polymer; (ii) exposing said mineral polymer to one or more pollutants; and optionally, (iii) regenerating the capability of the mineral polymer to reduce pollutants. Regeneration may be carried out by washing with a solvent, or heating. The solvent may be water or another suitable solvent.

The present invention relates to pollutant-reducing mineral polymers, in particular mineral polymers that sequester pollutants, for example, gases such as oxides of nitrogen (NOx) and oxides of sulphur (SOx), particulates and/or volatile organic compounds, uses of the mineral polymer for removing pollutants directly at source, from a ventilation system, or at the road side, methods of sequestering pollutants using the mineral polymer, and related products.

There are increasing concerns over air quality and levels of air pollution in the atmosphere, particularly air pollution resulting from human activity.

Air pollution is caused by introduction of particulates, gases or other harmful materials into Earth's atmosphere. These may arise from natural sources such as volcanic activity, or from anthropogenic sources, mainly the combustion of fossil fuels and biofuels. Combustion of fossil fuels and biofuels releases pollutant gaseous emissions such as oxides of nitrogen, carbon dioxide, carbon monoxide and sulphur dioxide. Often particulates, e.g. carbon, are also released.

Generally, air pollutants are either toxic compounds or the precursors to environmental problems such as acid rain deposition and photochemical smog. Exposure to air pollution has been linked to disease and even death in humans and animals, and can be damaging to other living organisms such as crops, to ecosystems and to the natural or built environment.

Indeed, according to the Royal College of Physicians, UK, each year around 40,000 deaths are attributable to outdoor air pollution in the UK. Moreover, health problems resulting from air pollution also have a significant financial impact on society as a whole, costing the UK more than £20 billion each year (Royal College of Physicians working party report, February 2016).

There is a need for materials that can reduce levels of pollutants in the atmosphere. In particular, there is a need for materials that can reduce levels of pollutant gases, volatile organic compounds (VOCs) such as volatile organic hydrocarbons and particulates in the atmosphere.

Traffic emissions are a dominant source of nitrogen oxides, volatile organic compounds and particulate matter in the urban atmosphere. For example, the UK light-duty vehicle fleet has a high proportion (˜33%) of diesel engines, which are known to contribute significantly to air quality degradation and consequently present a major challenge to human health. There is therefore a need for products that sequester the polluting emissions at their source, for example, to remove pollutants such as NOx, SOx, VOCs and particulates from the exhaust stream of a diesel or gasoline vehicle.

Occupants of urban vehicles are exposed to the high levels of pollution present in the main traffic routes. It has been reported that passengers of taxis, buses and other vehicles are often exposed to higher levels of pollution than pedestrians on road-side pavements. This results from the drawing in, through the ventilation system, of emissions from surrounding vehicles. There is a need for an effective filter material that removes pollutants, such as NOx gases, from air that is drawn through the ventilation system.

Air pollution in many major cities around the world is very high. For example, in the UK the air pollution often far exceeds the 40 μg/m³ annual average European target threshold for NO₂ concentrations in the environment. Oxford Street in London is a prime example where NO₂ pollution often exceeds 200 μg/m³. There is therefore a need for NOx mitigation on major highways.

One of the major forms of air pollution is particulate matter. These fine respirable particulates are of great concern and pose a major health risk. Currently, diesel particulate filters (with limitations) are used to capture particulates. However, there is a need for alternative or improved particulate filters, in particular those that are effective at removing other forms of pollutants, such as NOx gases such as NO₂, SOx gases such as SO₂ and/or volatile organic compounds (VOCs) such as volatile organic hydrocarbons.

Use of a mineral polymer as a binder, matrix, carrier or cement to immobilise non-mineral polymer absorptive or catalytic materials for reduction of pollutant gases is known. However, there remains a need for a mineral polymer material that is itself capable of removing pollutants without the addition of any additional catalytic, absorptive or adsorptive material.

At present many pollutant- or particulate-removing materials, such as those in filter cartridges or absorbent coatings, must be replaced with newly manufactured materials and/or it is not economically viable to recycle them for reuse. There is therefore a need for pollution sequestering materials that can be easily regenerated for reuse.

The present invention is directed at a pollutant-reducing mineral polymer that addresses some of the above-mentioned problems.

### SUMMARY

Accordingly, the first aspect of the invention provides a mineral polymer for reducing pollutants. The mineral polymer may be for one or more of: gas absorbing; absorbing pollutant volatile organic compounds such as volatile organic hydrocarbons; and capturing particulate pollutants.

Advantageously, the mineral polymer of the current invention is capable of removing pollutants without the addition of any additional absorptive, catalytic or adsorptive material. Thus, the pollutant-removing material of the present invention avoids the need for a separate physical support in the form of a non-functional matrix, carrier or binder material. A non-functional material plays no part in the pollutant absorption, and so represents functionally-unproductive weight, volume and cost. The material of the present invention is therefore more weight-, space- and cost-efficient.

Preferably, the mineral polymer is a metakaolin-based mineral polymer. More preferably, the mineral polymer is prepared from a mixture comprising around 7% to around 53%, for example, 20 to 30% metakaolin by weight.

Preferably, the mineral polymer comprises a porous structure. In some embodiments, the mineral polymer is a foamed mineral polymer and comprises one or more voids that are between 1 μm and 5 mm in diameter. The voids may be on the millimetre scale, for example between 50 μm and 5 mm in diameter. The porous structure may comprise one or more voids on the nanometre scale and/or one or more voids on the micrometre scale, for example between 1 μm to 3000 μm in diameter, preferably between 1 μm to 1000 μm. In embodiments of the invention, the voids are between 50 μm and 3 mm in diameter.

The second aspect of the invention provides the use of the mineral polymer according to the invention for reducing one or more pollutants. In embodiments of the invention, the use of the mineral polymer may be for absorbing one or more pollutant gases, such as NOx, SOx (such as SO₂) and/or CO₂. Alternatively or in addition, the mineral polymer may be used for absorbing pollutant volatile organic compounds such as volatile organic hydrocarbons and/or for capturing particulate pollutants.

A particular embodiment of the invention provides a use of the mineral polymer for sequestering pollutants produced by road vehicles, such as those powered by diesel engines. Accordingly, the mineral polymer may be configured to sequester pollutants directly from an exhaust stream, from a ventilation air flow (e.g. in an in-vehicle or building ventilation system), or from the road side.

A third aspect of the invention provides a method for reducing pollutants, the method comprising the steps: (i) providing a mineral polymer according the present invention; and (ii) exposing said mineral polymer to one or more pollutants.

In the method according to the invention, the one or more pollutant is or comprises one or more of a group comprising: a pollutant gas, such as NOx, SOx (such as SO₂) and/or CO₂; a volatile organic compounds such as volatile organic hydrocarbon; and particulates.

In an embodiment of the invention, the method further comprising the step (iii) regenerating the capability of the mineral polymer to reduce pollutants. Regeneration may be carried out by washing with a solvent, or heating. The solvent may be water or another suitable solvent. The regeneration may be carried out under positive or negative pressure. Carrying out regeneration under pressure is particularly useful for regeneration of mineral polymer that has been used for capturing particulate pollutants, such as in a filter.

A fourth aspect of the invention provides a method for preparing a mineral polymer of the present invention.

A fifth aspect of the invention provides a product comprising a mineral polymer of the present invention.

Embodiments of the invention comprising the mineral polymer may include, but are not limited to: a building material, a building, a structure, an item of furniture, a combustion engine, a vehicle, a ventilation system, a respiratory device or a filter for an exhaust system.

### FIGURES

The present invention is described with reference to the accompanying drawings in which:

FIG. 1 is a perspective illustration of a mineral polymer product according to an embodiment of the invention;

FIG. 2 is a cross-sectional illustration of the mineral polymer product of FIG. 1;

FIG. 3 shows the results of gravimetrical CO₂ uptake experiments on foamed (a) and unfoamed (b) samples of the mineral polymer of the present invention;

FIG. 4 is a photograph of an example reaction tube used for absorption spectroscopy experiments;

FIG. 5 is a photograph of an embodiment of the invention in the form of a mesh wafer or lattice;

FIG. 6 is a graph showing the concentration of NO₂ in a gas stream with alternating use of a reactor comprising the mineral polymer of the present invention;

FIG. 7 is a photograph of the results of a visual experiment showing the uptake of NO₂ by the mesh wafer of FIG. 5;

FIG. 8 is a photograph of an example set-up of a single pass cell used to measure absorption of NO₂ vs mass of mineral polymer;

FIG. 9 is a photograph of a disc-shaped, stackable absorbing element comprising the mineral polymer of the invention;

FIG. 10 shows graphs of NOx, NO₂ and NO absorbing capability of the mineral polymer of the invention according to different configurations of the exhaust pipe line (“raw”=no catalytic converter or mineral polymer; “Alsitek only”=mineral polymer but not catalytic converter; “CAT only”=catalytic converter only; “CAT+Alsitex”=both catalytic converter and mineral polymer) under conditions of the engine running at cold idle (exhaust flow rate: 36 l/s; exhaust temperature 83-90° C.);

FIG. 11 shows graphs of NOx, NO₂ and NO absorbing capability of the mineral polymer of the invention according to different configurations of the exhaust pipe line (“raw”=no catalytic converter or mineral polymer; “Alsitek only”=mineral polymer but not catalytic converter; “CAT only”=catalytic converter only; “CAT+Alsitex”=both catalytic converter and mineral polymer) under conditions of the engine running at 15% load at 2,000 RPM (exhaust flow rate: 62 l/s; exhaust temperature 175-190° C.);

FIG. 12 shows graphs of NOx, NO₂ and NO absorbing capability of the mineral polymer of the invention according to different configurations of the exhaust pipe line (“raw”=no catalytic converter or mineral polymer; “Alsitek only”=mineral polymer but not catalytic converter; “CAT only”=catalytic converter only; “CAT+Alsitex”=both catalytic converter and mineral polymer) under conditions of the engine running at 30% load at 2,000 RPM (exhaust flow rate: 62 l/s; exhaust temperature 290-310° C.);

FIG. 13 shows the absorption of ambient NO₂ at 10.5 l/minute by the mineral polymer of the invention;

FIG. 14 shows the removal of the VOC, methyl vinyl ketone (butanone/MVK), by the mineral polymer of the invention;

FIG. 15 shows an isometric view (a) and side view (b) of a product made from the mineral polymer of the present invention in a form referred to herein as a “hedge”;

FIG. 16 shows the concentrations of NO and NO₂ as a function of time within the sample volume in the absence of mineral polymer (only for NO₂; “NO₂ Baseline”), or in the presence of mineral polymer according to the invention (“NO—Sample A”; “NO₂—Sample A”; “NO—Sample B”; NO₂—Sample B”);

FIG. 17 is a photograph of a disc-shaped, stackable particulate filtration element comprising the mineral polymer of the invention having an open-cell foamed structure;

FIG. 18 shows the NO₂ measurements from a flow that passed through two elements of the mineral polymer according to the invention (“Flow through sample”) or did not pass through the elements (“Flow bypassed”);

FIG. 19 shows the cumulative absorption of NO₂ by the mineral polymer of the invention as function of time over a 5 hour period. The data has been fit with a single order function having the equation y=9.75*(1−exp(−0.0045*t)) suggesting a cumulative uptake limit of 9.75 g NO₂/90 g material; and

FIG. 20 shows the same data as FIG. 18 in which the fitted function has been extrapolated forward in time to apparent saturation.

### DETAILED DESCRIPTION

Accordingly, the first aspect of the invention provides a mineral polymer for reducing pollutants. The mineral polymer may be for one or more of: gas absorbing; absorbing pollutant volatile organic compounds such as volatile organic hydrocarbons; and capturing particulate pollutants. Preferably the mineral polymer is a metakaolin-based mineral polymer.

Surprisingly, it has been found that the mineral polymer of the present invention is able to absorb significant amounts of pollutants. It is envisaged that the polymer may find application for making products to be used to control pollution levels.

Even more surprising is the absorption affinity of the mineral polymers for NO₂ gas, even at the very low concentrations required to meet environmental standards.

Nitrogen oxides which include nitrogen oxide (NO) and nitrogen dioxide (NO₂) are important trace gases that make up the earth's atmosphere.

During daylight hours, NO reacts with partly oxidised organic species (RO₂) in the troposphere to form NO₂. In turn, NO₂ is photolysed by sunlight to reform NO.

NO+CH₃O₂→NO₂+CH₃O (Eq. 1)

NO₂+sunlight→NO+O (Eq. 2)

The oxygen atom formed in Equation 2 goes on to form tropospheric ozone.

As a result of these reactions, the sum of NO and NO₂ concentrations ([NO]+[NO₂]) tends to remain fairly constant i.e. in equilibrium, thus it is convenient to think of the two chemicals as a group; hence they are commonly referred to as “NOx”.

NO is short-lived and readily converts to NO₂ in the presence of excess free oxygen (O₂.⁻).

2NO+O₂→2NO₂ (Eq. 3)

NOx gases are also combustion products from internal combustion engines and fossil fuel electricity generation. The gases are poisonous pollutants and have been proved to be dangerous to the health of humans and other mammals.

NOx gases are also part of the chemical mechanism that produces the air pollution effect known as smog.

Many urban areas and traffic corridors regularly record NOx concentrations that are in excess of the maximum recommended levels, often three or four times higher. The resulting impact on human health is severe with premature death being the most extreme but common outcome in some cities.

Attempts have been made to remove roadside NOx by using the photocatalytic properties of titanium dioxide deployed as a coating or paint to roadside structures (Fujishima et al., 2000). However, full scale trials have shown that the rate of catalysis is insufficient to make a measurable difference in reducing roadside NOx levels, proving titanium dioxide an impractical solution to the problem.

The mineral polymers of the present invention have been found to absorb significant amounts of NO₂ gas. Thus, the mineral polymer of the present invention could be used to reduce or control levels of NOx in the atmosphere (see Equations 1-3).

It is envisaged that the mineral polymer of the invention would absorb significant and useful levels of other pollutant gases such as SOx (for example SO₂).

It has been found that the mineral polymer of the invention also absorbs VOCs, and when formed into a suitable format, can perform well as a particulate filter.

Thus, the mineral polymer advantageously can remove more than one form of pollutant.

For the purposes of this invention, the term “mineral polymer” is synonymous with the term “geopolymer”. Mineral polymers are a member of a class of synthetic aluminosilicate polymeric materials. They are formed by reacting, for example via dissolution, an aluminosilicate in an alkaline silicate solution or an acidic medium, which upon condensation (curing) forms a mouldable, homogeneous polymeric product. The raw materials for the preparation of mineral polymers are readily available.

The mineral polymer may be prepared from a mixture comprising around 7% to around 53% by weight of metakaolin. Preferably the mineral polymer is prepared from a mixture comprising 20 to 30% by weight of metakaolin.

The mineral polymer mixture may further comprise up to around 53% by weight, preferably to 30% by weight of mica. “Mica” would be known to those skilled in the art and refers to a group of sheet silicate (phyllosilicate) minerals. Common types of mica include biotite, lepidolite, muscovite, phlogopite, zinnwaldite and clintonite.

Preferably, the mica used in the present invention comprises a muscovite mica. Muscovite mica, otherwise known as common mica, isinglass, or potash mica is a phyllosilicate mineral of aluminium and potassium with formula KAl₂(AlSi₃O₁₀)(F,OH)₂, or (KF)₂(Al₂O₃)₃(SiO₂)₆(H₂O).

Alternatively, in the mixture mica may be wholly or partially substituted with one or more fillers. The one or more fillers may be selected from the list consisting of: wollastonite; chalk; molochite; cordierite; basalt; feldspar; zircon; graphite; and borax.

The mineral polymer mixture may further comprise an alkali metal silicate, for example around 26% to around 81% by weight of alkali metal silicate aqueous solution (the solution being around 30-50% w/w). Preferably, the alkali metal silicate is potassium silicate or sodium silicate, most preferably potassium silicate.

The mineral polymer mixture may further comprise an alkali metal hydroxide, for example around 5% to around 22% by weight of an alkali metal hydroxide. Preferably, the alkali metal hydroxide is potassium hydroxide. Mixtures of the alkali metal silicate and alkali metal hydroxide with different cations may be used (e.g. NaOH or KOH).

In some embodiment, fibrous materials, such as mineral fibres, may also be added to the reaction mixture to impart various physical properties, such as improved strength. The term “fibrous material” refers to a material consisting of, comprising or resembling fibres. Suitable fibrous materials include mineral fibres, carbon fibres, metal-based fibres, glass fibres, polymer-based fibres such as Kevlar® or cellulosic fibres.

Preferably, the mineral polymer of the present invention comprises a porous structure. The term “porous structure” refers to the presence of pores, voids and/or passages within a structure.

The extent and scale of the porous structure depends on the molecular structure of the material, additives used and the method of production. The term ‘scale of porosity’ refers to the size of the voids and/or passages within the structure e.g. a material where the voids have a maximum dimension in the range 1 to 1000 nm have a nanometre scale of porosity.

Preferably, the mineral polymer is a foamed mineral polymer.

In the context of the present invention, the person skilled in the art would understand what is meant by a foamed mineral polymer and non-foamed mineral polymer.

However, by way of example, a foamed material is a substance (e.g. a particle or other object) that is formed by bubbles of gas in the material, thus forming cells. As a result, a proportion of the internal volume of a foamed substance is a gas such that the density of a substance is lowered as the content of gas is increased. A non-foamed material should be substantially free of cells, although small numbers of cells may be present, such as might be introduced from a preparative method.

The foamed mineral polymer material may contain a network of gaseous voids (cells) throughout its volume which may take an open- or closed-cell arrangement.

In accordance with the present invention, the foamed mineral polymer would preferably have between 5 to 95% of its internal volume consisting of gaseous voids. In preferred embodiments, the foamed mineral polymer may have greater than 5%, and more preferably greater than 10% of its internal volume consisting of gaseous voids. In embodiments of the invention, the foamed mineral polymer has greater than 40%, preferably greater than 60% of its internal volume consisting of gaseous voids.

The term “internal volume” refers to any part of the material defined by the geometrical envelope of a mineral polymer material. Thus, gaseous voids may be enclosed in the material or on the surface of the material. The nanoporous nature of typical geopolymer is shown in Bell et al. (2006).

A blowing or foaming agent is used in the preparation of the foamed mineral polymer material. The foaming agent is generally added just before pouring or moulding the material. Preferably, hydrogen peroxide is used, but finely divided aluminium or other gas producing material, such as another metal may also be used. In the case of hydrogen peroxide, there is a reaction with the alkaline chemistry of the mixture that breaks the hydrogen peroxide down into water and gaseous oxygen. It is the oxygen evolved in the reaction that provides the blowing within the bulk of the material that creates the voids.

A foam modifier may also be used in the preparation of the foamed mineral polymer material to control the level of openness of the foam. Thus, a foam modifier promotes the formation of an open pore/cell structure, which enables gas containing pollutants to pass through passages in the superstructure of the cured foam. A foam modifier is used in combination with a foaming agent. Microorganisms, such as yeast or algae, or proteins may be used as a foam modifier. Alternatively, the foam modifier may be polystyrene (for instance Styrofoam®), preferably in the form of fine expanded polystyrene particles, more preferably in the form of very fine expanded polystyrene particles. The Styrofoam® is thus powdered. Yeast has been found to be particularly useful in preparing open-cell foamed mineral polymers. Foam modifier proteins of the invention may be enzymes, for example, catalase.

Open-cell foamed mineral polymers are particularly suitable for particulate filters, and may be particularly suitable for NOx, SOx or VOC absorption.

Thus, the mineral polymer mixture may further comprise around 0.0012% to around 15%, preferably around 0.01% to around 15% of a foaming agent. In particular, if hydrogen peroxide or light metal power is used as a foaming agent, it is preferably present in an amount of around 0.01% to around 15%.

The mineral polymer mixture may further comprise around 0.0012% to around 10% of a foam modifier, which is used in combination with foaming agent.

Alternatively, a gas may be incorporated mechanically e.g. by mixing analogously with whipped egg whites.

Alternatively, the mineral polymer mixture may be foamed by boiling the water in the mixture, for example by applying negative pressure to the mixture or by heating the mixture such as by applying microwaves or radiant heat to the mixture.

In some embodiments of the invention, the foamed mineral polymers may comprise a structure of porosity on the millimetre scale. That is they have, because of their molecular structure, voids (pores) and/or passages within the structure that are on the millimetre scale, for example, voids with a dimension in the range 50 μm and 5 mm. This scale of porosity may result from the addition of a blowing agent (foaming stage) in the preparation of the mineral polymer.

Preferably, the foamed mineral polymer materials are also nanoporous. That is they have, because of their molecular structure, voids and/or passages within the structure that are on the nanometre scale, for example, voids with a dimension in the range 1 nm to 1000 nm. Advantageously, such porosity allows small molecules to pass into the apparently solid structure.

In some embodiments of the invention, the foamed mineral polymers may further comprise a structure of porosity on the micrometre scale, for example, having voids with a dimension in the range 1 μm to 3000 μm, preferably 1 μm to 300 μm. As an example, it has been found that when the mineral polymers are made from a mixture comprising filler materials, a structure of porosity on a micrometre scale is created.

For example, the mineral polymer may be prepared from a mixture further comprising up to 55% by weight of filler, preferably 35 to 55% by weight of a filler, more preferably 40 to 45% by weight of a filler. In an embodiment, the mixture comprises 41.5% by weight of filler.

The nano and microporosity of mineral polymers was investigated in the study by Bell et al. (2006) as well as other investigations into the phenomenon.

The implication of the high degree of very fine porosity is an extremely high specific surface area available for absorption in the order of four or five orders of magnitude higher than the flat surfaces of titanium dioxide previously proposed for the purpose of mitigating NOx emissions.

The term “filler” would be understood by those skilled in the art and may be functional fillers or mineral fillers. Organic fillers such as plant materials may also be employed. The filler of the geopolymer foam of the present invention can be selected from any material which already contains pockets, cell or voids of gas or gaseous material. By way of example such fillers include glass microspheres, aeroclays, pearlite and vermiculite.

In an embodiment, the mineral polymer is prepared from a mixture comprising about 20-30% by weight of a metakaolin, about 20-30% by weight of a muscovite mica, about 35-55% by weight of a filler, about 1-10% by weight of an alkali metal hydroxide, up to 100% by weight, which may include one or more fibrous materials.

In another embodiment, the mineral polymer is prepared from a mixture comprising about 23-28% by weight of a metakaolin; about 22-27% by weight of a muscovite mica; about 40-45% by weight of a filler, about 5-10% by weight of an alkali metal hydroxide; and about 0.1-3% by weight of the blowing agent, up to 100% by weight, which may include one or more fibrous materials.

In another embodiment, the mineral polymer is prepared from a mixture comprising about 25% by weight of a metakaolin; about 24% by weight of a muscovite mica; about 41.5% by weight of a filler, and about 8% by weight of potassium hydroxide and about 0.3% by weight of the blowing agent, up to 100% by weight, which may include one or more fibrous materials.

In an embodiment, the mineral polymer is prepared from a mixture comprising 20 to 30% by weight of a muscovite mica, about 35-50% by weight of an aqueous alkali metal silicate solution (with 15 to 45% by weight of alkali metal silicate), about 1-10% by weight of an alkali metal hydroxide, and about 1-5% by weight of hydrogen peroxide, up to 100% by weight.

More preferably, the mineral polymer is prepared from a mixture comprising about 23-28% by weight of a metakaolin; about 22-27% by weight of a muscovite mica; about 40-45% by weight of an aqueous alkali metal silicate solution (30-50% w/w); about 5-10% by weight of an alkali metal hydroxide; and about 1-3% by weight of hydrogen peroxide, up to 100% by weight.

Even more preferably, the mineral polymer is prepared from a mixture comprising about 25% by weight of a metakaolin; about 24% by weight of a muscovite mica; about 41.5% by weight of an aqueous alkali metal silicate solution; about 8% by weight of potassium hydroxide (about 29% by weight of alkali metal silicate); and about 1.5% by weight of hydrogen peroxide.

Preferably, the foamed geopolymer material used in the invention has a density of 0.1 to 1.5 g/cm³, 0.1 to 0.9 g/cm³, 0.1 to 0.8 g/cm³ or0.3 to 0.8 g/cm³. The density of the foamed geopolymer material may depend on a number of factors, for example, the type and particle size of the filler and the mass of blowing agent added have a significant influence on the density of the resultant mineral polymer material.

Some embodiments of the invention may just have one level and type of porosity e.g. nanoporous. Alternative embodiments may have more than one scale and type of porosity e.g. having voids and/or passages within their structure on a nanometre and/or micrometre and/or a millimetre scale.

The combination of multiple scales or types of porosity mean that mineral polymer materials formed in this way offer a large specific surface area for the absorption of certain gases and liquids.

In some embodiments of the invention, the mineral polymer may be prepared from a mixture further comprising talcum. The term “talcum” would be understood by those skilled in the art and include for example soap stone and stearite.

The type of talcum used has been found to have an effect on the homogeneity and size of the pores/voids of the mineral polymer. By varying the amount and type of talcum, it has been found that the size and consistency of the macro level of porosity can be controlled. For example, ‘No chlorite, microcrystalline talc, ultrafine D50=1 μm’ was found to result in homogeneous and small pore sizes whereas ‘No chlorite, microcrystalline talc, fine D50=25 μm topcut’ was found to result in more homogeneous but larger pores.

The addition of talcum also imparts lower density to the foam which can advantageously reduce the volumetric cost and increase the specific surface area of the product.

Thus, talcum may be present in the mineral polymer mixture in an amount of up to around 36% by weight.

In embodiments of the invention, graphite or surfactants may replace some or all of the talcum in the mixture.

In an embodiment of the invention, the foamed mineral polymer is prepared from a mixture comprising around 7 to around 22% by weight of metakaolin, up to around 53% by weight of mica, around 26 to 81% by weight of a metal silicate preferably potassium silicate, around 5% to around 22% by weight of an alkali metal hydroxide and preferably potassium hydroxide, water, around 0.01 to around 15% by weight of a foaming agent such as hydrogen peroxide or non-ferrous metal powder and optionally around 0.0012 to 10% by weight of a foam modifier such as yeast and up to around 36% by weight of talcum.

In an example embodiment, the foamed mineral polymer is prepared from a mixture comprising 20-30% by weight of metakaolin, 9-16% of mica, 10-20% by weight of a metal silicate preferably potassium silicate, 6-13% by weight of an alkali metal hydroxide and preferably potassium hydroxide, 27-39% water, 0-4% by weight alkali resistant glass fibre, 0.5-6% by weight hydrogen peroxide or non-ferrous metal powder or other blowing agent and 0.5-4% by weight of talcum.

As an example, the mixture may comprise 14.5% by weight potassium silicate, 8.7% by weight of potassium hydroxide, 32.4% water, 25% metakaolin, 12.3% mica, 1.5% alkali resistant glass fibre 3.8% hydrogen peroxide and 1.8% of talcum.

A second aspect of the invention provides the use of the mineral polymer according to the invention for reducing one or more pollutants. In embodiments of the invention, the use of the mineral polymer may be for absorbing one or more pollutant gases, such as NOx, SOx (such as SO₂) and/or CO₂. Alternatively or in addition, the mineral polymer may for absorbing pollutant volatile organic compounds such as volatile organic hydrocarbons and/or for capturing particulate pollutants.

A particular embodiment of the invention provides a use of the mineral polymer for sequestering pollutants produced by road vehicles, such as those powered by diesel engines. Accordingly, the mineral polymer may be configured to sequester pollutants directly from an exhaust stream, directly from a ventilation air flow, or indirectly from the road side.

A third aspect of the invention provides a method for reducing pollutants, the method comprising the steps: (i) providing a mineral polymer according to the invention; and (ii) exposing said mineral polymer to one or more pollutants.

In the method according to the invention, the one or more pollutant is or comprises one or more of a group comprising: a pollutant gas, such as NOx (such as NO₂), SOx (such as SO₂) and/or CO₂; a volatile organic compounds such as volatile organic hydrocarbons; and particulates.

Preferably, the one or more gases comprise NOx.

Preferably, NOx is absorbed selectively over other gases present in the atmosphere such as argon, nitrogen, oxygen, ammonia.

In an embodiment of the invention, the method further comprises the step (iii) regenerating the capability of the mineral polymer to reduce pollutants. Regeneration may be carried out by washing with a solvent, or heating. The solvent may be water or another suitable solvent. Regenerating may occur under positive or negative pressure.

For passive, road-side uses, the ability of water to regenerate the performance of the material, enables regeneration by rainfall. This provides a convenient means to reuse the material, thus minimising waste.

Surprisingly, regeneration may in fact increase the ability of the material to absorb pollutants such as NOx, in particular NO₂.

A fourth aspect of the invention provides a method for preparing a mineral polymer of the present invention.

A fifth aspect of the invention provides a product comprising a mineral polymer of the present invention.

The mineral polymer product may be formed by such techniques as extrusion, additive manufacturing, reaction injection moulding, transfer injection moulding, die casting or gravity moulding into appropriate shapes to accept pollutant gases.

A variety of applications and embodiments of the mineral polymer gas absorber according to the present invention are envisaged. The mineral polymer material may be formed into any number of different shapes for products or parts of products with the purpose of absorbing pollutants, for example gases such as NOx, SOx or VOCs, or filtering particulates. Alternatively, the mineral polymer may be directly incorporated into the design of structures or products such as buildings and vehicles.

It is envisaged that the mineral polymer may be situated for use near to or adjacent to the source of the pollution, for example, along a busy road, runway, in or adjacent the exhaust stream of a vehicle engine.

The mineral polymer may be used in the creation of both functional and/or aesthetic structures such as sculptures. It is envisaged that the mineral polymer could be used as an alternative to conventional materials.

The shapes of structures or products made from the mineral polymer may be designed in such a way to maximise the surface area accessible by the target gases. For example, the products or parts may be formed to provide an “open” structure such that wind may blow through the structure rather than blow around the part.

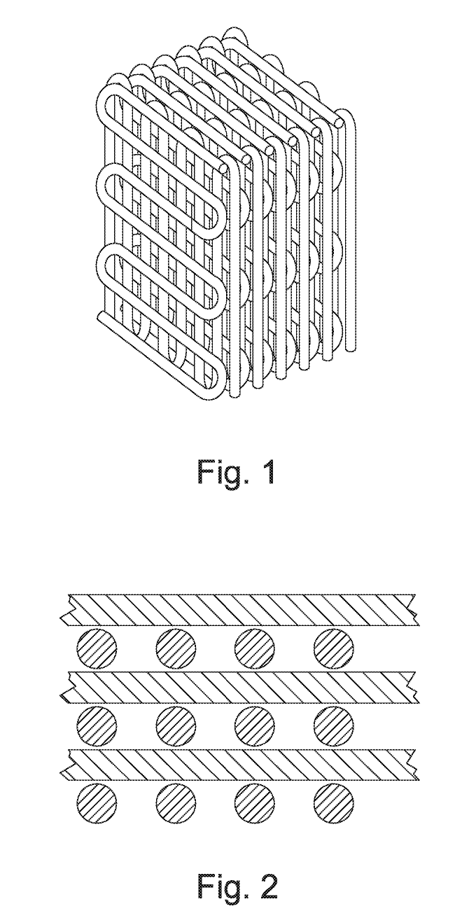

In some embodiments, the mineral polymer may comprise a three dimensional lattice or mesh of extruded strands of the mineral polymer, for example, see FIGS. 1 and 2.

The structure illustrated in FIGS. 1 and 2 may be formed of, for example, a foamed mineral polymer prepared from a mixture comprising about 25% by weight of a metakaolin flash calcined at approximately 750° C.; about 24% by weight of a muscovite mica; about 41.5% by weight of an aqueous potassium silicate solution; about 8% by weight of potassium hydroxide and about 10.5% by weight of a blowing agent.

Alternatively, the structure may be formed of a non-foamed geopolymer material prepared from a bulk mixture consisting of 25% by weight of metakaolin flash calcined at approximately 750° C.; 24% by weight of a muscovite mica; 43% by weight of a 29% by weight aqueous potassium silicate solution; and 8% by weight of potassium hydroxide.

The mineral polymer structure is a three dimensional lattice of extruded strands of the mineral polymer of a nominal size. The structure is self-supporting. Further embodiments of the structure (not shown) may comprise additional supporting structures made of a suitable material. Care must be taken when choosing which material to use as an additional support as there are often problems with differential thermal expansivity when attaching mineral polymers to other materials. Mineral polymers are recognised to have the lowest thermal expansivity in a system. The term thermal expansivity is recognised as the tendency of matter to change in volume in response to a change in temperature through heat transfer and this is the interpretation intended. A suitable support material is steel reinforcements.

The purpose of the structure is to provide a solid barrier to roadside wind and breezes that has the strands sufficiently far apart that the air would pass through the structure, rather than passing around it thus presenting a large surface area to the air.

Whilst the air passes through the structure the NOx, SOx and VOC molecules are absorbed and the air therefore purified. Such a lattice may be formed to provide a panel, pillar or other shapes, placed by the roadside.

In an alternative embodiment, the mineral polymer may be in the form of rock-like or pebble shapes and may be contained within structures such as gabions as part of shoring or landscaping features.

In an embodiment, the mineral polymer of the present invention may be formed as a very thin sheet or ribbon. The sheet would be made as thin as possible to obtain the largest surface area possible per unit of mass without loss of strength necessary to prevent the sheet from being able to support its own weight. As an example, the thickness of the sheet may be in the range 0.2 mm to 4 mm.

Furthermore, it is envisaged that the mineral polymer according to the present invention may be formed in the shape of street furniture, for example, benches, posts, and signposts.

An embodiment of the invention is a structure constructed out of the mineral polymer of the invention. This structure may be in the form of a wall or “hedge” of the material. The structure is described as a hedge because, like a natural hedge, air can pass through the structure, contacting surfaces within the outer boundary of the structure.

Such structures consist of building blocks that have an open structure. These building blocks may further have features moulded onto them that allow them to engage mechanically with one another so that the structure may be built accurately and strongly.

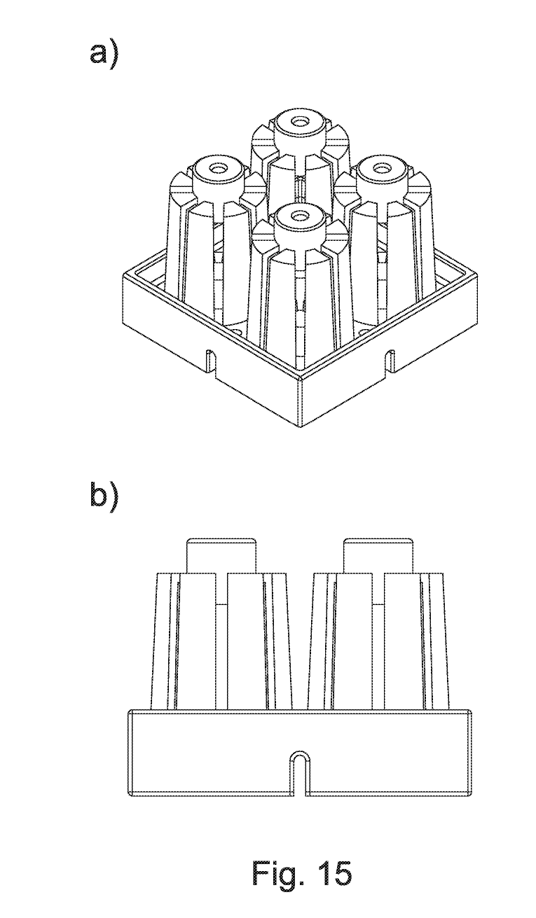

A particular example of such a block is shown in FIG. 15 (a). It has four features on the top that may engage with hollow features on the underside of other blocks placed on top of them. Moreover the block shown has circular features to support the engaging features provided with slots that pass through the circular features to allow the passage of air though the blocks.

The slots and engaging features are also seen in the side view, shown in FIG. 15 (b).

The particular property of mineral polymers that allows such interlocking blocks to be made is its ability to be moulded with near zero in-mould shrinkage, which allows very accurate components to be made.

The block shown in FIG. 15 has four engaging features but these blocks may be cast to have any number of engaging features as appropriate to the application. A typical arrangement might be an eight feature block, arranged in two rows of four. Such a block may be built into a structure in much the same way that a common building brick for house construction is used.

Another example of a building block comprising the mineral polymer of the invention is blocks of a size similar to normal construction concrete blocks. These blocks might be provided with similar locating features as the hedge design, or a different system. They would, however be made in such a way that, like the block in FIG. 15, they allow the free movement of air through them.

Because of the very low density of the mineral polymer foam, it would also be possible to make blocks considerably larger than concrete construction blocks that would be easy enough to manipulate manually or still larger blocks handled by mechanical means.

Alternatively, architectural features of buildings may be provided that comprise the mineral polymer of the present invention.

Alternatively, the mineral polymer may be used in building ventilation systems or in respiratory devices to purify air.

Alternatively the mineral polymer material may be formed into a filter or cartridge for an exhaust system with a multiplicity of gas channels in it.

Embodiments of the invention include uses of the mineral polymer in the following:
aircraft cabin air purification systems;
road tunnel ventilation systems;
railway tunnel ventilation systems;
railway stations and/or platforms;
train ventilation systems, optionally non-electric train ventilation systems, optionally wherein the train is a diesel train;
stationary generator systems, optionally in urban areas;
air purification systems at shipping ports, airports and/or other localised pollution hotspot areas;
non-road vehicle engines, optionally wherein the engines are railway engines, aircraft engines and/or ship engines;
filters to remove pollution as a result of the combustion of fuel, optionally wherein the fuel is diesel, gasoline, kerosene, aviation fuel, heavy marine fuel light marine fuel and/or biofuel;
removal of VOCs from high VOC generating activities such as paint and coating activities e.g. in vehicle factories;
linings for fabrics such as clothing, or furniture coverings;
masks and other personal protection equipment;
building integrated pollutant mitigator;
chemical and laboratory processing, optionally of gasses and VOCs; and
use in production of agricultural chemicals, for instance as a fertiliser.

The mineral polymer may be used for coating a surface, e.g. by pasting, optionally in designed patterns and/or in variable thicknesses. The mineral polymer may be strengthened and/or bulked-up with fibres. The surface may be, for example, part of a road-side structure such as a sound barriers.

The mineral polymer may further comprise sensors to monitor the pollutant saturation level and/or the regeneration status (particularly in an exhaust system). The sensors may trigger or report actions. The triggered action may be to close down the engine of a stationary vehicle.

The mineral polymer may further comprise solar power cells to power sensors and/or air flow generators configured to draw pollutants through or around the material. Air flow generators would remove the dependence on wind and air movement from vehicles and people.

An embodiment of the invention is a collection facility for collecting by-products produced on the mineral polymer of the invention during exposure of the mineral polymer to one or more pollutants, the collection facility comprising the mineral polymer and a container configured to collect the by-products in the form of run off from the mineral polymer.

An embodiment of the invention is an evaporation systems to create powdered residue comprising the mineral polymer of the invention.

In a particular embodiment, the mineral polymer may be part of an active pollution reduction system comprising self-standing units on a street or by a road or by a runway, optionally comprising solar and/or battery power, sensors, mobile phone and/or computer software for analysis and remote reporting of performance. This system optionally creates and collects residues for commercial re-use.

Embodiments of the invention are portable versions to enable immediate remediation.

### Definitions

A “pollutant gas” is a gas whose presence in the atmosphere above a critical level causes harm directly or indirectly to the environment.

The term “mineral polymer” for the purposes of the present invention is synonymous with the term “geopolymer”. Mineral polymers are a member of a class of synthetic aluminosilicate polymeric materials.

A “foamed mineral polymer” is a mineral polymer comprising trapped pockets or voids of gas. A blowing or foaming agent is used in the preparation of a foamed mineral polymer.

“Metakaolin” would be known to those skilled in the art and refers to a dehydroxylated form of the clay mineral kaolinite.

“Mica” would be known to those skilled in the art and refers to a group of sheet silicate (phyllosilicate) minerals.

A blowing agent, also referred to as foaming agent or gaseous agent may be any blowing agent suitable in the preparation of geopolymer materials including hydrogen peroxide or non-ferrous metals such as aluminium powder or zinc powder.

“Nanoporous material” or “nanoporous structure” refers to a material or structure comprising pores generally 1000 nm or smaller. IUPAC has subdivided nanoporous materials in to three categories: microporous (pore size 0.2-2 nm), mesoporous (pore size 2-50 nm) and macroporous (pore size 50-1000 nm).

The term “scale of porosity” refers to the size of the pores, voids and/or passages within a structure e.g. a material comprising a porous structure where the voids have a maximum dimension in the range 0 to 1000 nm have a scale of porosity on the nanometre scale.

The term “fibrous material” refers to a material consisting of, comprising or resembling fibres.

The “filler” may be any filler suitable in the preparation of geopolymer materials and may be a functional fillers, mineral fillers or organic fillers such as plant materials.

The “talcum” may be any talcum suitable in the preparation of geopolymer materials.

All terms used throughout the specification unless otherwise defined should be given their everyday meaning as understood by the skilled person.

### EXAMPLES

### Example 1—CO₂ and NO₂ Absorption

To demonstrate the gas absorption capabilities of the mineral polymer of the present invention, gravimetric tests were conducted that showed an affinity of the material with CO₂.

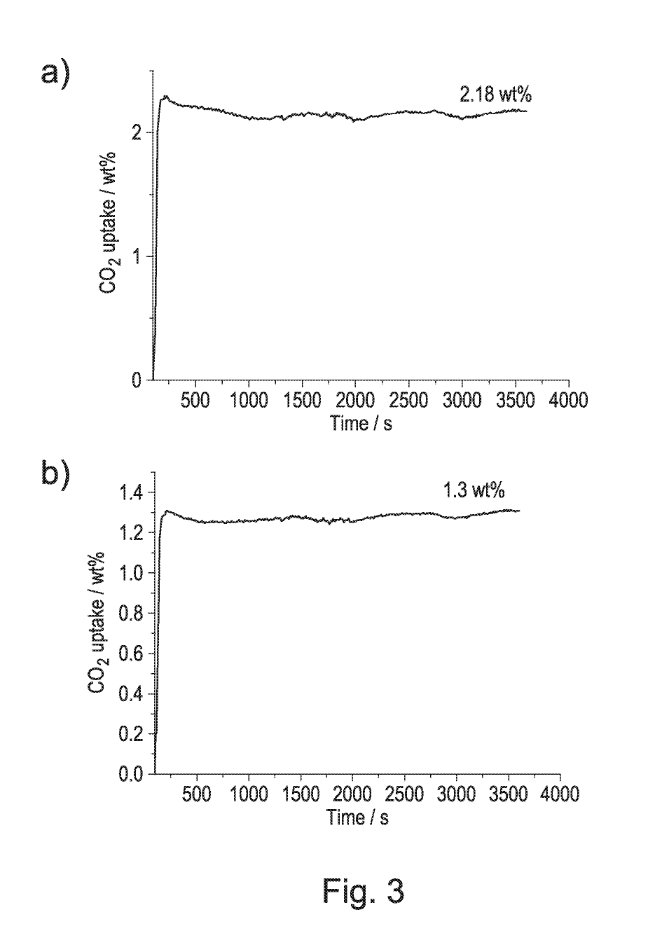

FIG. 3a) shows the uptake of CO₂ of a sample of foamed mineral polymer of the present invention.

FIG. 3b) shows the uptake of CO₂ of a sample of unfoamed mineral polymer of the present invention.

The tests were carried out on samples consisting of ground pieces of mineral polymer foam according the present invention, of between 0.5 mm and 1 mm in diameter. The samples were first heated to 600° C. to drive off any already absorbed gases and then exposed to 100% CO₂ at 1 bar, 25° C.

The material picked up 2.18% and 1.3% of its mass respectively for foamed and unfoamed material, in CO₂ within a few seconds as shown in FIGS. 3a) and b) and then became saturated represented by the horizontal portion of the graphs.

The mineral polymer was found to absorb at least 21 g CO₂ gas per kg of mineral polymer material.

To further investigate the gas absorption capabilities, tests for NO₂ absorption were conducted. The mineral polymer material of the present invention was found to have a surprisingly high affinity for NO₂.

The tests were designed to find out if the material could reduce the concentration levels in the test reactor from an above limit concentration of 50 μg/m³ of NO₂ to below the limit of 40 μg/m³.

Surprisingly, the material reduced the concentration not just to below the limit but down below detectable concentrations, that is below 1 μg/m³. Concentrations as low as 40 μg/m³ can be reduced down below detectable levels (1 μg/m³)

In view of the equilibrium between NO/NO₂ gases (Equations 1-3) and since NO in the atmosphere readily converts to NO₂, the results of the studies confirm the potential of the mineral polymer to remove NOx gases from the atmosphere.

The following tests were performed:

A. Absorption Spectroscopy

This test was set up to determine:
Is the mineral polymer capable of reducing the concentration of NO₂ in an airflow from a level of 50 μg/m³ to at least below 40 μg/m³? The former figure being over the accepted maximum concentration and a typical roadside level and the latter, the accepted maximum.
If it is capable of such a concentration reduction, how far below 40 μg/m³ can the material drive the concentration?

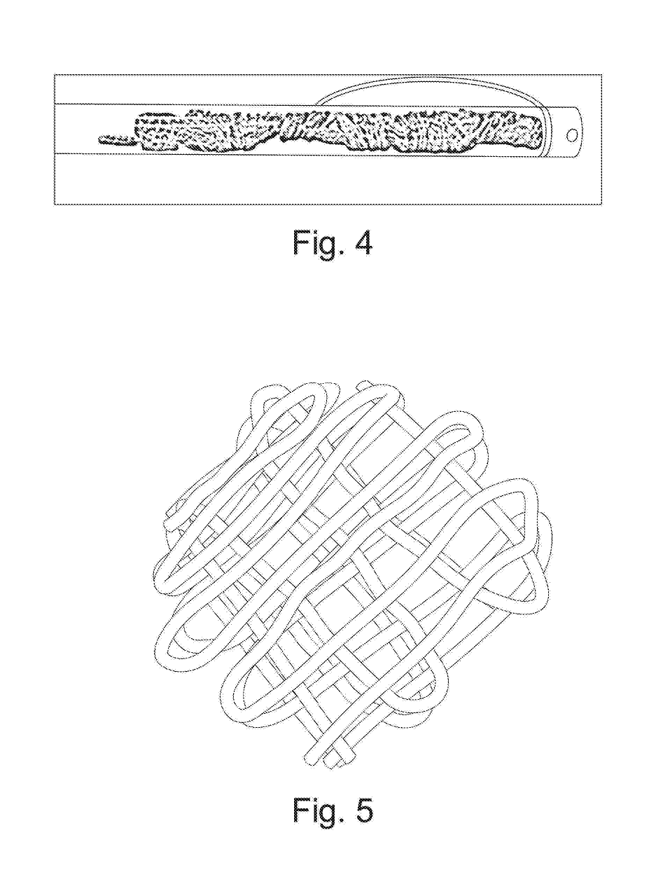

The apparatus consisted of a glass reaction tube 800 mm long and 50 mm diameter, see FIG. 4. The tube was filled with mesh wafers of the mineral polymermaterial, see FIG. 5.

A flow of air that was loaded with approximately 50 μg/m³ NO₂ at 70% relative humidity was introduced at one end of the tube and the output flow from the tube fed into a cavity enhanced absorption spectrometer to measure the output level of NO₂.

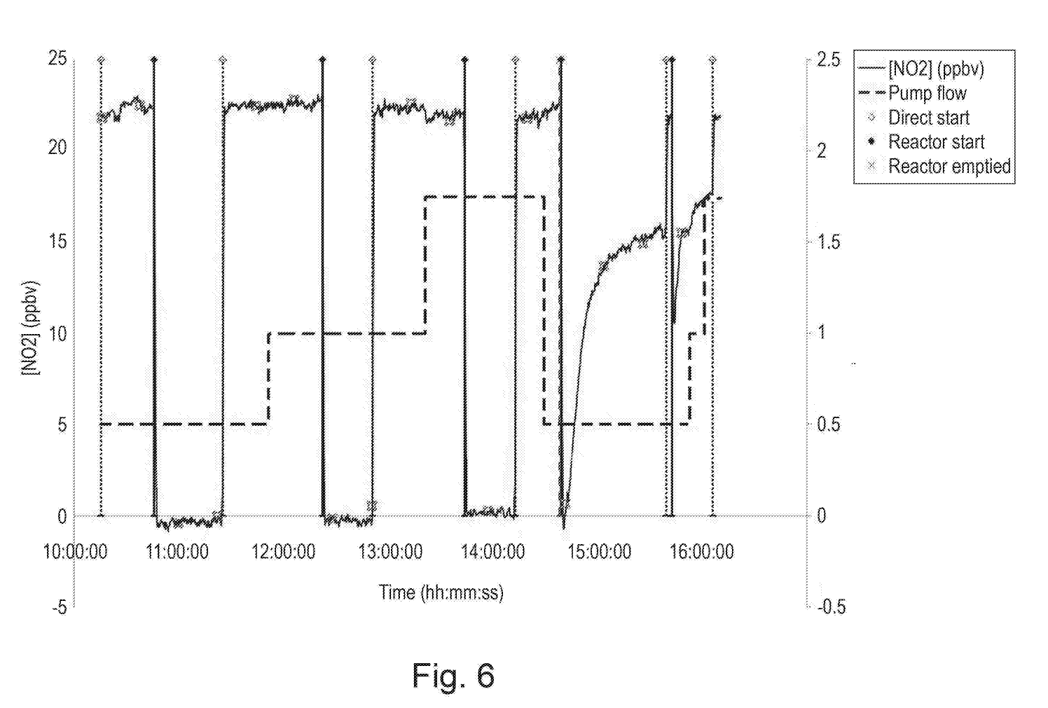

The graph depicted in FIG. 6 shows the three experiments done using this apparatus.

The initial section shows the input gas concentration being fed directly into the spectrometer to verify the concentration (shown here at an average of 43 μg/m³).

The second section shows the output concentration at a flow rate of 0.5 litres per minute (l/m). The output concentration is measured to be below detectable limits (2 μg/m³).

The third section again confirms the input concentration as the flow rate is increased to 1 l/m. The fourth section again shows the output concentration below detectable limits. The fifth section confirms the input concentration as the flow rate is increased to 1.5 l/m. The sixth section again shows the output concentration below detectable limits. The seventh section is a final confirmation of the input concentration.

These results show a surprisingly high rate of removal of NO₂ from the airflow, much more than was anticipated when designing the experiment.

Such a powerful absorptive capacity changed what was needed to further explore the approximate level of feasibility of the use of mineral polymer as an absorbent of NO₂.

It has been found that the mineral polymer according to the present invention may absorb NO₂ at concentrations less than 2 μg/m³ and may absorb at least 3 g NO₂ per kg of mineral polymer material.

A test to indicate the rate of uptake that is possible and also a test to determine whether a significant loading of NO₂ into the material was possible was then proposed.

B. Visual Experiments

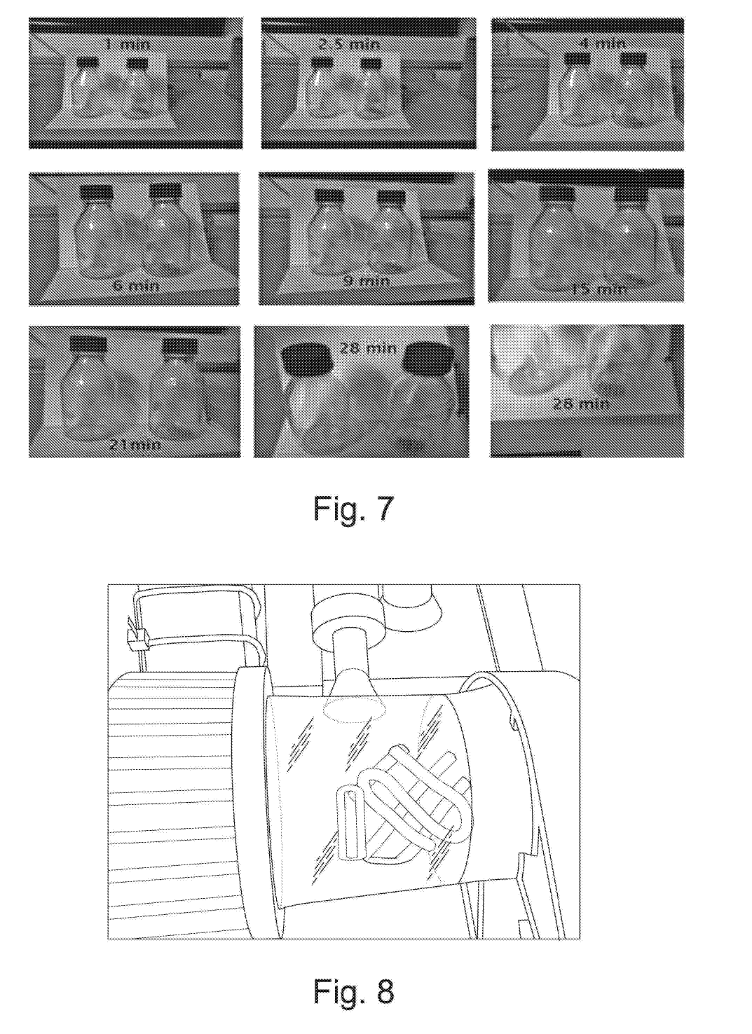

A visual experiment was performed to assess the NO₂ concentration required for further quantitative experiments. The results are shown in FIG. 7.

The apparatus constituted a pair of 0.5 l sealed vessels each containing NO₂ at 0.7% concentration and room air at ambient relative humidity (RH). The vessel on the right also contained a piece of mineral polymer weighing 2.599 g.

NO₂ is a gas with a reddish-brown colour. NO₂ gas was clearly present in both vessels at the start of the test and within four minutes it was visibly reducing in concentration in the vessel containing the mineral polymer. By 9 minutes the characteristic colour is almost completely absent.

The brown colour was visually observed to disappear in the bottle containing the mineral polymer in under 10 minutes (uptake rate was around 0.07% min⁻¹).

After 28 minutes, the brown colour had disappeared and gravimetric analysis showed the mass uptake in the piece of mineral polymer to be 0.011 g.

This was a crude range finding test but proved graphically a high removal rate.

C. Absorption of NO₂ Versus Absorbent Mass

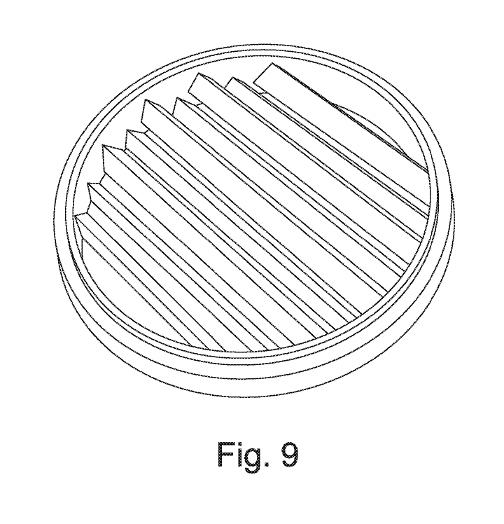

A single pass cell was designed to get an initial order of magnitude for the mass proportion of NO₂ that the mineral polymer material was capable of consuming. A smaller glass tube reactor was used to expose NO₂ to the absorbent. The setup is shown in FIG. 8.

By injecting NO₂ into the reactor at varying absorbent masses it was possible to ascertain absorption rates and loading of NO₂ into the material. See Table 1 below.

TABLE 1
Absorption of NO₂ versus absorbent mass

| | NO₂ | Volume of | | | |
|---|---|---|---|---|---|
| | con- | gas flowed | Sample | Mass | Absorbed |
| Comment | centration | (1) | mass(g) | NO₂(g) | (g/kg) |
| Initial | 48 mg.m⁻³ | 89.0 | 197.6 | 4.3e−6 | 2.2e−5 |
| experiment | | | | | |
| High NO₂ | 0.0155 | 0.136 | 1.936 (1) | 0.0045 | 2.32 |
| concentration | (=1.55%) | | | | |
| in small | 0.0078 | 0.136 | 1.936 (2) | 0.0028 | 1.17 |
| absorption | (=0.78%) | | | | |
| cell | 0.0074 | 0.136 | 3.320 | 0.0022 | 0.65 |
| | (=0.74%) | | | | |
| | 0.0208 | 0.136 | 6.168 | 0.0061 | 0.98 |
| | (=2.08%) | | | | |

The single pass cell was made to hold in one instance 1.936 g of material. The sample had not been dried or heated beforehand.

NO₂ at a concentration of 1.55% in Nitrogen was then passed over the material sample. The result was the absorption of 4.3 mg of NO₂ which translates to 2.2 g/kg.

Then NO₂ at a concentration of 0.78% was passed over the same sample and a further 2.2 mg was absorbed, which amounted to a further 1.17 g/kg equivalent being taken on.

This experiment showed that at least 3.3 g/kg could be absorbed but that by no means demonstrated a limit of absorption in fact it showed that more than that was likely to be possible but further testing would be needed to ascertain how much.

Table 1 shows the amount of NO₂ absorbed per mass of sample. The figures are not saturation levels but merely the levels reached with the amounts of gas introduced. Therefore in the first injection to the 1.936 g sample the loading level was equivalent to 2.32 g/kg. On the second injection extra loading took place equivalent to 1.17 g/kg more. Clearly the saturation level would be higher than the sum of these.

TABLE 2
Absorption Rates

| Mass Absorber (g) | Rate const min⁻¹(k) | Rate/g. sample |
|---|---|---|
| 1.936 (experiment | −2.089 | −1.074 |
| 1a) | | |
| 1.936 (experiment | −1.275 | −0.658 |
| 1b) | | |
| 3.320 | −3.303 | −0.996 |
| 6.168 | −5.589 | −0.906 |

Table 2 shows the uptake rates for different masses of sample. It shows:
1. Uptake rate slows as amount of NO₂ already absorbed goes up. Indicating a saturation point.
2. Size of sample is inversely related to uptake rate. Indicating a geometric effect on uptake rate.

### Example 2—Mass Manufacturing Methods

To understand the feasibility of producing large scale structures for the roadside absorption of NO₂ by the mineral polymer, it was necessary to evaluate potential mass manufacturing methods.

One such method that was used at the laboratory scale to produce the elements tested above was extrusion.

In order to evaluate the basic feasibility of extrusion as a method of mass production a larger scale non-manual method was needed. A vacuum extruder supplied by Lucideon (formerly the Ceramic Research Institute) was used for the trial.

The extrusion trial successfully showed that the technique was very suitable for production of large scale structures from extruded members.

### Example 3—Use of Mineral Polymer in an Exhaust System to Absorb NOx

A 1.9 SDI, normally aspirated Volkswagen diesel engine was coupled to a dynamometer (Armfield CM12 Diesel Engine rig) to enable the engine to be operated at selected sets of load and speed conditions representative of urban and motorway driving conditions.

To gain a comprehensive understanding, the efficiency of the mineral polymer of the invention as a means of removing NOx from a diesel exhaust was evaluated using the engine operating conditions listed in Table 3. Although the cold idle condition is short lived (a few minutes), it is found to be highly polluting and has a distinctly high primary NO₂ fraction of the emitted NOx. The 15% load is representative of the average load applied to light duty engines in urban driving situations, while the speeds of 1,500 and 2,000 rpm represent short journeys and driving in urban zones. Average journey times are short and the proportion of the journey made whilst vehicle engines are running cold, with sub-optimal combustion and inefficient exhaust treatment can be substantial.

A particular problem is the very high emissions arising before the catalyst “light-off” temperature has been reached. The 2,500 and 3,000 rpm speeds are more representative of driving on faster roads such as motorways. On the other hand, the 30% load represents a situation where an engine is operated at a higher load (e.g. driving up-hill). The final condition of “hot idle” represents an engine in a car stopping at a junction or at a traffic light while the engine is hot. The different conditions provide a range of exhaust temperature and flow rates, which enable the testing of the efficiency of the mineral polymer of the invention to remove nitrogen oxides under a range of temperatures and flow rates (i.e. residence times) which are listed in Table 3 below:

TABLE 3
A summary of engine operating conditions and exhaust characteristics

| | Temperature | Calculated Flow |
|---|---|---|
| Engine Operating Conditions | (° C.) | Rate (1/s) |
| Cold idle* (0% load & 1150 rpm) | 83-90 | 28 |
| 15% Load & 1500 rpm | 140-160 | 44 |
| 15% Load & 2000 rpm | 175-190 | 63 |
| 15% Load & 2500 rpm | 210-230 | 86 |
| 15% Load & 3000 rpm | 230-250 | 107 |
| 30% Load & 2000 rpm | 290-310 | 79 |
| Hot idle** (0% load & 1150 rpm) | 170-130 | 35 |

*Engine was started from cold and was operated under no load for the duration of the measurements over a few minutes
**Engine was operated under no load following its operating for approximately 45-50 minutes over the range of load and speed conditions listed in the table above.

For the analysis, a steel canister was constructed to accept disc-shaped, stackable absorbing mineral polymer elements (FIG. 9). The elements were made by moulding. The mixture used to produce the elements was as follows:

| Ingredient | % w/w |
|---|---|
| Potassium silicate | 32.05 |
| solution (aqueous; | |
| around 30-50% w/w) | |
| KOH | 7.69 |
| Water | 9.41 |
| Metakaolin | 24.79 |
| Mica | 23.50 |
| Talcum | 1.28 |
| H₂O₂ | 1.28 |

The canister was designed in a way that it was able to be inserted into the exhaust line. Various configurations were used to determine its effectiveness in different set ups.

The following four exhaust configurations were tested:
1. Raw exhaust (no catalytic converter or mineral polymer of the invention in the exhaust line);
2. Mineral polymer of the invention only in the exhaust line;
3. Euro-4 catalytic convertor only in the exhaust line; and
4. Euro-4 catalytic convertor and mineral polymer of the invention in the exhaust line.

Nitrogen oxides were measured in exhaust emissions following controlled dilutions using a NO—NO₂-NOx Analyser, (Model 42i, Thermo, USA). NO, NO₂ and total NOx concentrations were measured during these tests, along with the back pressure before the absorbing element and the temperature at three places along the length of the absorbing canister.

The loading at 15% and 30% was used in the present tests because most vehicle miles are spent below 30% of full load. As stated previously, the majority of urban driving takes place at 15% load whereas the 30% load represents a situation where an engine is operating at a higher load (e.g. driving up-hill).

The results of the removal efficiency of the mineral polymer of the invention are listed in Tables 4 and 5.

TABLE 4
Percentage removal efficiency of NOx, NO and NO₂ by the mineral polymer of
the invention relative to the reference runs of raw exhaust and EURO-4 CAT only

| | Alsitek Material Only^{$} | | | | EURO-4 CAT & Alsitek Material | | | |
|---|---|---|---|---|---|---|---|---|
| | NOₓ | NO | NO₂ | f_{NO2}* | NOₓ | NO | NO₂ | f_{NO2}* |
| Engine Operating Conditions | % | | | | % | | | |
| Cold Idle (0% load & 1150 rpm) | 60 | 52 | 72 | 29 | 78 | 69 | 85 | 32 |
| 15% Load & 1500 rpm | 8 | (−2) | 29 | 22 | — | — | — | 37 |
| 15% Load & 2000 rpm | 19 | 9 | 33 | 18 | 39 | 28 | 61 | 36 |
| 15% Load & 2500 rpm | 24 | 13 | 37 | 18 | 29 | 22 | 52 | 32 |
| 15% Load & 3000 rpm | 4 | (−4) | 22 | 19 | — | — | — | 41 |
| 30% Load & 2000 rpm | (−7) | (−13) | 22 | 27 | 24 | 23 | 72 [symbol] | 64 [symbol] |
| Hot Ifiledle (0% load & 1150 rpm) | — | — | — | 33 | — | — | — | 32 |

*Percentage reduction of the fraction of NO2 of total NOx relative to the reference configuration (in the absence of the Alsitek material)
^{$}Note the very low NO₂ fraction and mixing ratio associated with this specific measurement [symbol]
indicates data missing or illegible when filed

TABLE 5
Evaluation of the Alsitek Disc for the removal of NOx, NO and NO₂ at cold idle engine condition

| | Euro-4 Catalytic convertor | | | | Euro-4 Catalytic convertor & Alsitek Disc | | | |
|---|---|---|---|---|---|---|---|---|
| | NOx | NO | NO2 | f_{NO2}** | NOx | NO | NO2 | f_{NO2}** |
| Engine Operating Conditions | PPM* | | | % | PPM* | | | % |
| Cold idle (0% load & 1150 rpm) | 580 | 255 | 325 | 56 | 268 | 220 | 47 | 18 |

| | Removal Efficiency (%) | | | |
|---|---|---|---|---|
| | NOx | NO | NO2 | f_{NO2} |
| Cold idle (0% load & 1150 rpm) | 54 | 14 | 85 | 68 |

*Mixing ratios in ppm corrected for dilution
**Fraction of NO₂ from total NO₂ calculated as ([NO₂]/[NO₂])*100%

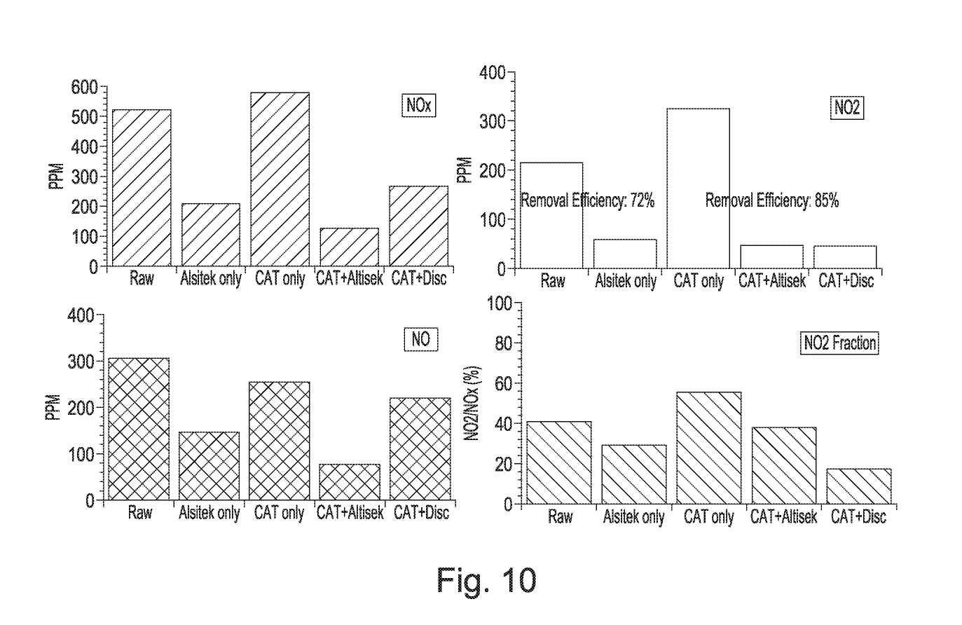

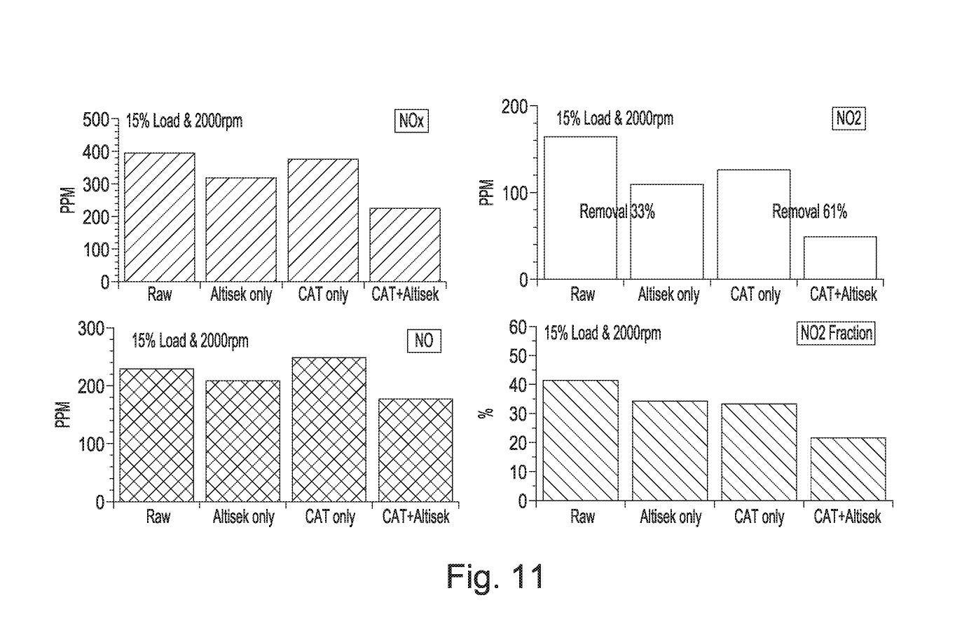

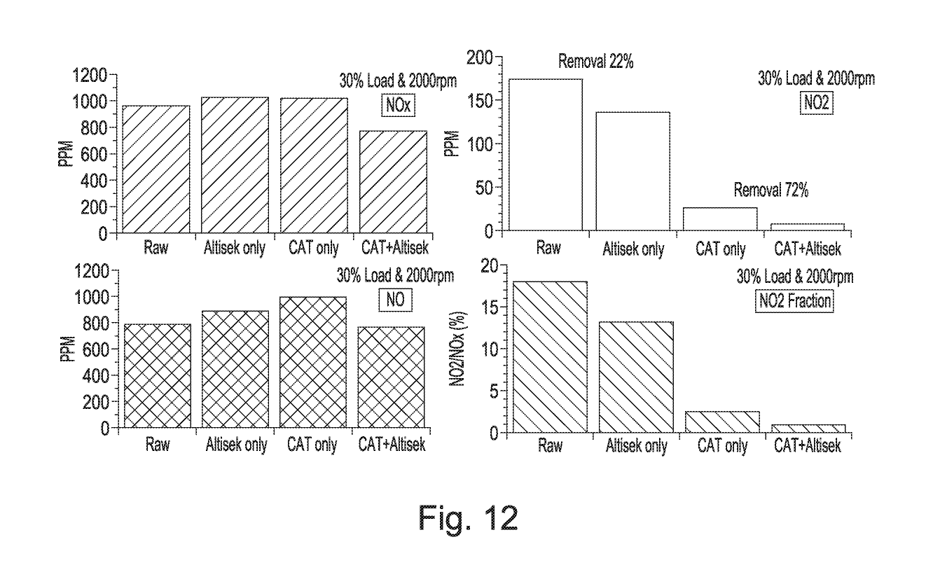

It was found that the mineral polymer of the invention is an effective sequester (also known known as scrubber) of NOx in all the engine operating conditions tested during the study (Tables 4 and 5; FIGS. 10, 11 and 12). The results listed in Table 4 (and FIG. 10) demonstrate the ability of the mineral polymer of the invention to remove NO and NO₂ with a removal efficiency of 52% and 72% respectively at the cold idle engine operating condition compared to raw, untreated exhaust (i.e. without the use of the Euro-4 catalytic convertor in the exhaust line). This suggests that the material worked well for both forms of nitrogen oxides under relatively cold exhaust temperature (˜90° C.) and a relatively low exhaust flow rate of 28 l/s (i.e. relatively high residence time).

The results indicate that under higher exhaust temperatures and flow rates (the rest of the engine operating conditions), the efficiency of the mineral polymer of the invention decreases but remains significant for the removal of NO₂, and becomes small for the removal of NO. The use of the mineral polymer of the invention downstream of a Euro-4 catalytic convertor in the exhaust line appears to improve its ability to remove both NO and NO₂ at all selected engine conditions, where 85% of NO₂ was removed under cold idle conditions and 61% and 52% of NO₂ were removed under conditions representative of urban and motorway driving respectively. In this setup downstream of a Euro-4 catalytic convertor, the mineral polymer of the invention appears to significantly remove NO₂ under engine conditions from cold idle to 15% and 30% load.

The results in Table 5 indicate the mineral polymer of the invention in the form of a disc (FIG. 9) removes NO₂ from diesel exhausts, where the use of only one disc resulted in the removal of 85% of the NO₂ under cold idle conditions.

Finally, the pressure drop caused by the mineral polymer of the invention did not cause issues and there was no visible strain on the engine as a result of the mineral polymer of the invention being part of the exhaust flow. The pressure remained below 10 kPa, whereas for diesel engines, 10-40 kPa back pressures are acceptable (Mayer, 2004).

### Example 4—Use of Mineral Polymer for in-Vehicle Ventilation Systems

The suitability of the mineral polymer of the invention to act as a filter for in-vehicle ventilation systems was analysed. The aim was to use ambient levels of NOx and determine the efficiency of the material for NOx in ambient air with low residency times.

For the analysis, a steel canister was designed and constructed to accept moulded, disc-shaped, stackable absorbing elements (FIG. 9).

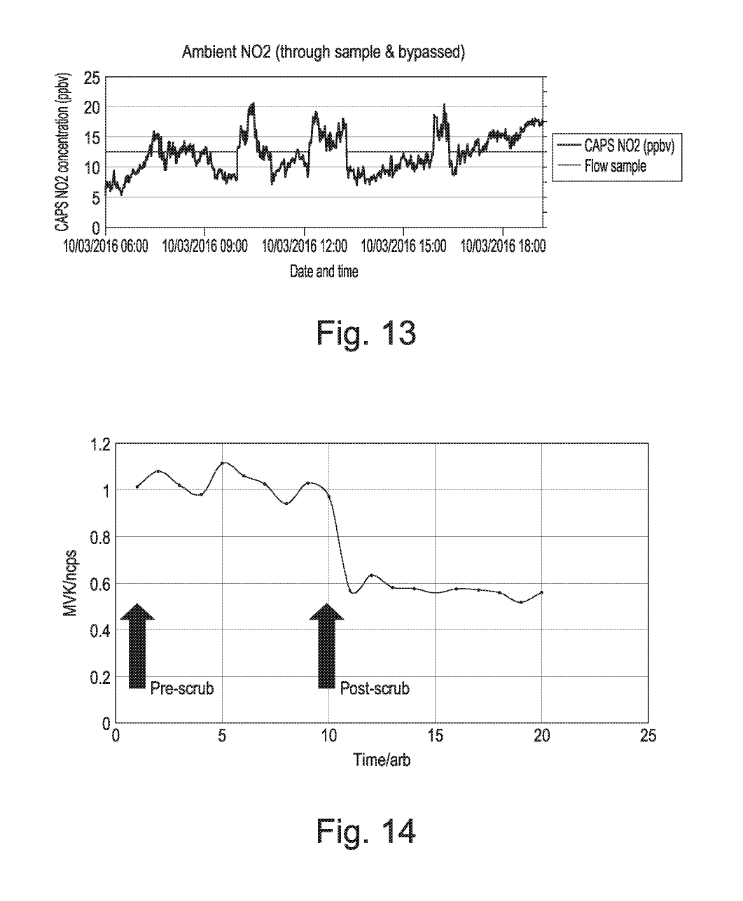

Experiments were carried out to determine the ability of the material to absorb NO₂ from ambient air at a higher flow rate of 10.5 l/min. It was found that the material was able to significantly reduce the concentration of NO₂ in ambient air (FIG. 13).

More than 50% of NO₂ was removed, which is a significant reduction, and the concentration could be further reduced by recirculating the air through the filter more than once.

The very toxic VOC, Methyl Vinyl Ketone (Butenone/MVK), was flowed through the mineral polymer of the invention at a flow rate of 5 l/min and it was found that the material was effective at removing MVK. Around 50% of the MVK was removed (or “scrubbed”) by the mineral polymer of the invention on a single pass (FIG. 14; “Pre-scrub” vs “Post-scrub”).

### Example 5—Use of Mineral Polymer as Roadside Pollutant Absorber

### Computer Fluid Dynamic Modelling

Computer Fluid Dynamic modelling (CFD) software was used to gauge the ability of the mineral polymer of the invention to mitigate NO₂ in urban streets and in the vicinity of roads by “passive absorption”. Computer based simulations of street configurations were used to assess how the material could best be deployed for air quality “hot-spot” mitigation beside roads. CFD analysis was carried out to assess the ability of the mineral polymer of the invention to mitigate NO₂ pollution in one of the world's most polluted roads, Oxford Street in London, UK.

The simulation was carried out in two scenarios where the mineral polymer of the invention was exposed to two different wind speeds of 4.6 m/s (London yearly average wind speed) and 1 m/s (low wind speed). Eight wind directions were used to take into account different street canyon configurations.

1.5 m high by 50 cm wide “hedges” made up of the mineral polymer (the width of the hedge is not crucial), and having the form illustrated in FIG. 15, were added on each side of the road. The hedges were removed in front of all the main intersections.

Vertical hedges of the material were shown to effectively reduce NO₂, especially at the average pedestrian height of 1.5 m, reducing street concentrations up to 35%. Greater reductions were observed for the 4.6 m/s wind speed than for the 1 m/s wind speed. The turbulence caused at higher wind speeds is likely to increase the contact between the NO₂ molecules and the material, which would explain why greater reductions are observed at a wind speed of 4.6 m/s.

The analysis carried out using the CFD software clearly demonstrates that the mineral polymer of the invention has the potential to be a very strong mitigator of NO₂ pollution. The simulation is also considered to be a conservative estimate as it assumes that the hedges are solid, whereas in practice their geometry would be modified to allow air to pass through them and hence maximise their available surface area and efficiency. In addition, the model does not include passive sink concentration gradients that clearly exist and would enhance the performance.

### Passive Absorption Experiments and Theoretical Calculations to Support the CFD Calculations

The NO₂ and NO absorption capabilities of the mineral polymer of the invention were tested using a diffusive absorption system to evaluate the material for atmospheric fixation of NOx near roadways. This laboratory analysis for the passive absorption was carried out using an MKS Multigas Fourier Transform Infrared (FTIR) spectrometer and theoretical calculations.

Removal rates of NOx were measured for concentrations ranging from 1-200 ppm NO and NO₂ background when flow was not externally advected through the material. Two sets of samples were tested (sample A and sample B).

It was found that the absorption rate by the mineral polymer of the invention was higher than the rate of NOx delivery to the surface, and thus the material was able to adsorb the NOx at a rate in excess of delivery rates within diffusive or weakly advected flows.

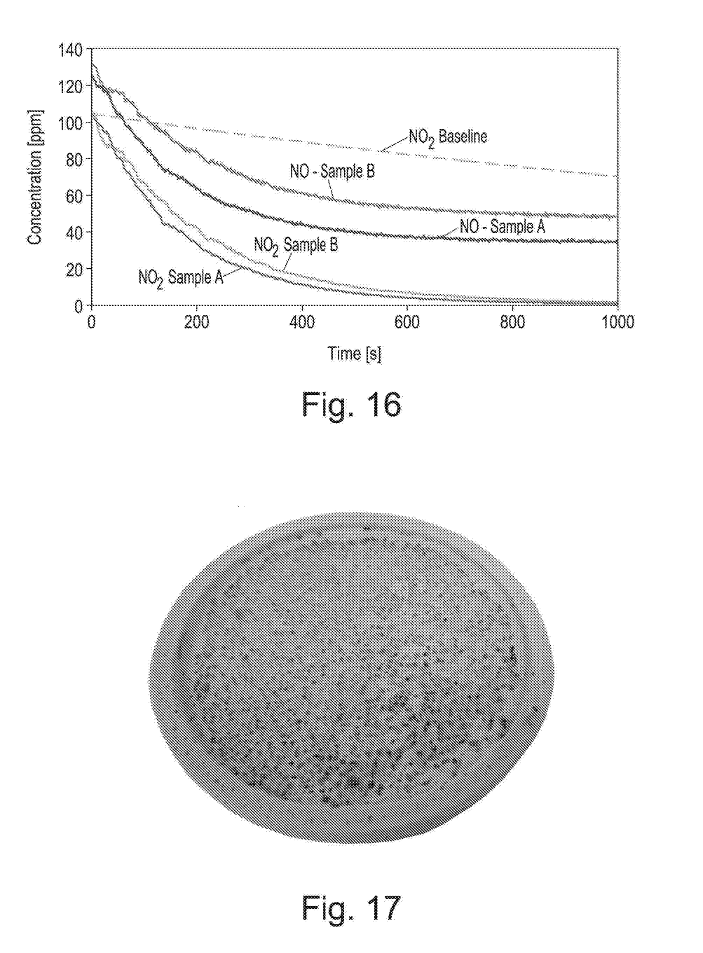

The measurement of NO and NO₂ species within the volume indicated a significantly greater reduction in NOx versus time when the mineral polymer of the invention was present (see FIG. 16). Due to the absorptive nature of the material, background levels of NO and NO₂ were only able to reach 100-150 ppm even when the chamber was being filled at 7 l/min Once the gas within the system was circulated the NO₂ concentration dropped dramatically relative to the baseline measurements.

As shown in FIG. 16, the NO₂ concentrations beginning at ˜100 ppm achieved a 90% reduction within 500 seconds. The drop in concentration of NO₂ was so much greater than the Baseline (a control condition that did not achieve a 50% reduction throughout the test), and it is evident that the absorption rates of the samples were significant.

The reduction in concentration over time indicates that the material is an almost ideal absorber of NO₂ while NO absorption is slightly limited at high ppm levels, and both species are absorbed at a rate that is greater than what would be delivered by diffusion to the surface in any likely urban environment.

A theoretical analysis of the maximum removal of NOx above a flat plate composed of perfectly-absorbing material indicates that concentrations can be reduced by an order of magnitude at 0.1 m within 2.5 hours. But at distances farther from the surface the material requires longer times to achieve reductions. The mineral polymer of the invention is capable of further reductions of NOx in ambient systems if flow is actively advected onto the material surface, for example by driving flow near the surface of the material with solar induced natural convection driven flow. This is in line with the finding from the CFD analysis.

### Example 6—Use of Mineral Polymer in an Exhaust System to as a Particulate Filter

The particulate filtration efficiency of the mineral polymer of the invention was studied. The testing involved the analysis of the filtration efficacy of the mineral polymer of the invention by evaluating its filtration performance with a laboratory-generated soot aerosol at staged particle sizes in the PM2.5 range, generated from a burner. The aim was to provide an indication of the material's suitability as a particulate filter for exhaust emissions.

Foamed filter elements of mineral polymer according to the invention, comprising an open cell structure, were prepared by moulding (FIG. 17). The mixture used to produce the elements was as follows:

| Ingredient | % w/w |
|---|---|
| Potassium silicate | 36.84 |
| solution (aqueous; | |
| around 30-50% w/w) | |
| KOH | 8.84 |
| Yeast | 0.29 |
| Water | 10.81 |
| Metakaolin | 20.30 |
| Mica | 19.26 |
| Talcum | 1.13 |
| H₂O₂ | 2.53 |

Elements exhibited nearly 50% filtration efficiency for a single element and 70-80% efficiency for five elements in series for carbonaceous soot particles of relevant size to diesel ultrafine particles (50-60 nm mean diameter). The elements having smaller pore sizes exhibited consistently better filtration efficiencies and surprisingly more favourable pressure drops than the larger pore size samples.

Surprisingly, the elements were found to preferentially filter out smaller particles, and filtration efficiencies reached above 94% for particles of 20 nm mean diameter. The mean particle diameter after the filtration was above 55 nm, compared with 50 nm for no filter. The increase in particle diameter is likely due to the preferential capture of smaller sized particles.

### Example 7—Foamed Mineral Polymer Formulation

Foamed filter elements of mineral polymer according to the invention, comprising an open cell structure, were prepared by moulding. The mixture used to produce the elements was as follows:

| Ingredient | % w/w |
|---|---|
| Potassium silicate solution | 31.7 |
| (aqueous; around | |
| 30-50% w/w) | |
| KOH | 7.6 |
| Very fine Styrofoam ® | 6.4 |
| Water | 9.3 |
| Metakaolin | 24.6 |
| Mica | 17.6 |
| H₂O₂ | 2.8 |

### Example 8—Saturation and Regeneration

The saturation properties of the material and the regeneration (i.e. removal of pollutants from the material to enable reuse) of the saturated material were characterised.

### Saturation Properties of the Material

Gas was passed through the material to determine its efficiency and also allowed to bypass the canister containing the elements. A measured flow rate of 1.7 l/min at a known NO₂ concentration were used to determine the mass of gas per minute passing through the material.

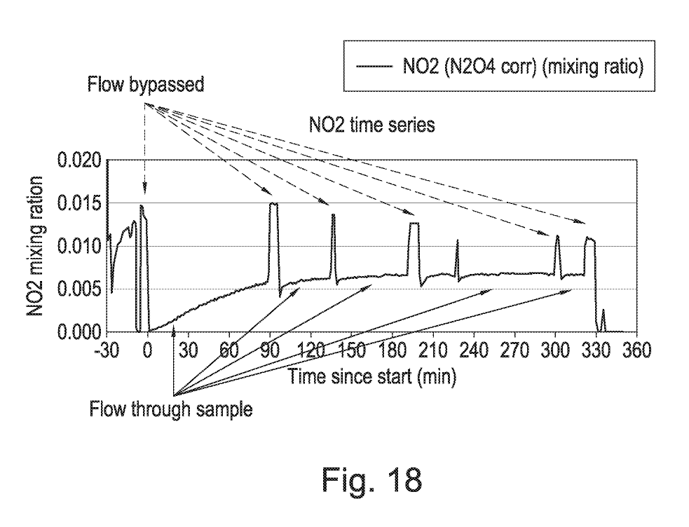

It was found that the material had excellent NO₂ absorbing capabilities, capturing all the NO₂ that was flowed through the material (FIG. 18).

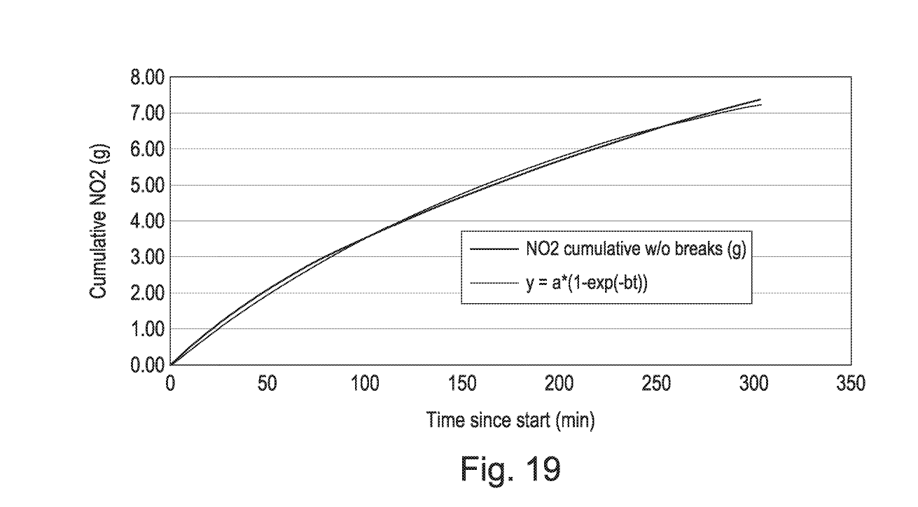

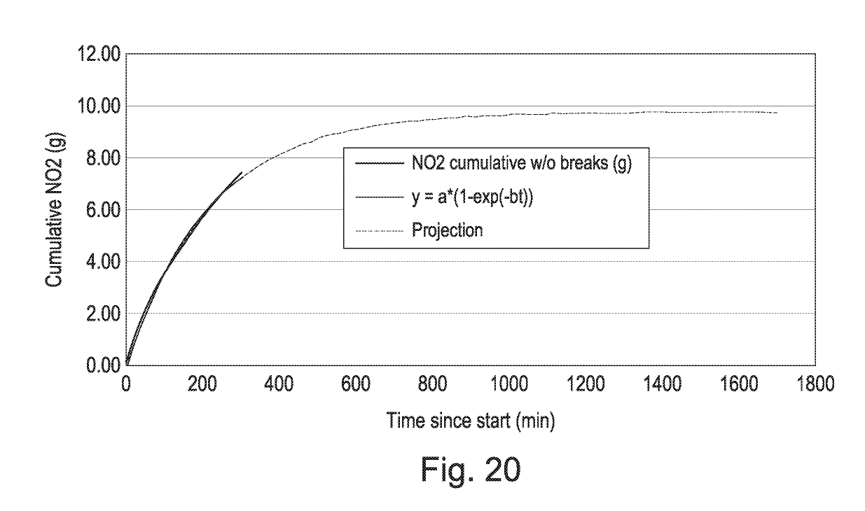

The mineral polymer of the invention was exposed to NO₂ at a concentration of 1.5% for five and a half hours without saturation. FIGS. 19 and 20 demonstrates that the total absorption of NO₂ was a very surprising 10% by weight of material.

A decrease in NO of 2.2% was observed when the gas was passed through the material.

It is believed that the level of NO absorption could be enhanced by oxidising NO to NO₂ then removing the resulting NO₂ by the mineral polymer of the invention.

### Regeneration of the Material

Tests were carried out to establish whether the saturated material could be regenerated and whether, once regenerated, it would be able to absorb NO₂ at the same rate and to the same extent as previously.

Thermal Regeneration

Thermal regeneration testing was designed to measure and quantify the chemical species of heat evolved gases and the temperatures at which they were produced. The saturated/tested elements, moulded to the form shown in FIG. 9, were exposed to high temperatures to regenerate them. The regenerated samples were then retested to ensure that the material was still able to absorb the NOx gases as effectively as when it was new.

It was found that there was a release of NO₂ from the saturated material when it was exposed to temperatures in excess of 200° C. However, not all of the NO₂ absorbed was released upon heating, at least not in the form in which it was before absorption. Therefore, either not all of the NO₂ was released on heating, or it had been converted to something else.

It was found that, in addition to NO₂ being released when the gas was bubbled through 70 ml of distilled water, the pH dropped to 1 after an hour suggesting that an acid of nitrogen may be being produced.

After the heating experiment, the regenerated material again showed excellent NO₂ absorption capabilities showing that it can be regenerated to its previous absorptive state through heating.

Solvent Regeneration

The solvent washing tests were carried out using water as the solvent. Saturated elements made according to FIG. 9 were soaked in water and the dissolved nitrogen chemical species in the wash water was quantified. Samples were then dried and retested in the saturation test to confirm that the material was regenerated by washing.

Experiments using solvent washing with water shows that there is a release of nitrate (NO3—aq.) and nitrite (NO₂—aq.) through washing. This correlated with the findings from the regeneration-by-heat experiments, which also resulted in the formation of an acid.

Following regeneration through washing, the material was regenerated to its previous state and could then continue to absorb. Surprisingly, the capacity of the element for NO₂ uptake increased from 10% by its own weight to 15%. Surprisingly, washing the material with water enhanced its absorptive capacity.

### REFERENCES

J L Bell, M Gordon and W M Kriven (2006) Nano- and microporosity in geopolymer gels, Microscopy and Microanalysis 12.S02: 552-553.
Akira Fujishima, Tata N. Rao, Donald A. Tryk (2000) Titanium dioxide photocatalysis, Journal of Photochemistry and Photobiology C: Photochemistry Reviews, 1:1-21.
Mayer, A., 2004. “Number-based Emission Limits, VERT-DPF-Verification Procedure and Experience with 8,000 Retrofits”, VERT, Switzerland (from https://www.dieselnet.com/tech/diesel_exh_pres.php).
Royal College of Physicians. Every breath we take: the lifelong impact of air pollution. Report of a working party. London: RCP, 2016. (www.rcplondon.ac.uk/projects/outputs/every-breath-we-take-lifelong-impact-air-pollution)

1. A mineral polymer, for reducing pollutants.

2. The mineral polymer according to claim 1, for gas absorbing.

3. The mineral polymer according to claim 1, for absorbing pollutant volatile organic compounds such as volatile organic hydrocarbons.

4. The mineral polymer according to claim 1, for capturing particulate pollutants.

5. The mineral polymer according to claim 1, wherein the mineral polymer is metakaolin-based.

6. The mineral polymer according to claim 1, prepared from a mixture comprising around 7% to around 53% metakaolin by weight, preferably 20 to 30% metakaolin by weight.

7. The mineral polymer according to claim 1, comprising a porous structure.

8. The mineral polymer according to claim 7, wherein the porous structure comprises one or more voids 1 to 1000 nm in diameter, between 50 μm and 5 mm in diameter, or between 1 μm to 3000 μm in diameter.

9. (canceled)

10. (canceled)

11. The mineral polymer according to claim 7, wherein the porous structure forms an open-cell or closed-cell arrangement.

12. The mineral polymer according to claim 7, wherein the mineral polymer is formed from a mixture comprising a foaming agent and a foam modifier.

13. The mineral polymer according to claim 12, wherein the mixture comprises yeast as a foam modifier.

14. Use of the mineral polymer according to claim 1, for reducing one or more pollutants.

15. The use of the mineral polymer according to claim 14, for absorbing one or more pollutant gases.

16. The use of the mineral polymer according to claim 15, wherein the pollutant gas is or comprises one or more selected from the group: NOx; and SOx.

17. The use of the mineral polymer according to claim 16, wherein the NOx is NO₂, and wherein the SOx is SO₂.

18. (canceled)

19. The use of the mineral polymer according to claim 15, wherein the pollutant gas is or comprises CO₂.

20. The use of the mineral polymer according to claim 14 for absorbing pollutant volatile organic compounds such as volatile organic hydrocarbons.

21-41. (canceled)
